(19) United States
(12) Patent Application Publication
(10) Pub. No.: US 2003/0236940 A1
(43) Pub. Date: Dec. 25, 2003

(54) Method for repeatedly recording program in flash memory

(75) Inventors: Vincent Wu, Taoyuan Hsien (TW); Sam Chang, Taoyuan Hsien (TW)

Correspondence Address: BACON & THOMAS, PLLC, 625 SLATERS LANE, FOURTH FLOOR, ALEXANDRIA, VA, 22314

(73) Assignee: GVC CORPORATION, Taoyuan Hsien (TW)

(21) Appl. No.: 10/200,738

(22) Filed: Jul. 24, 2002

(30) Foreign Application Priority Data
Jun. 25, 2002 (TW) 091113944

(51) Int. Cl. G06F 12/00

(52) U.S. Cl. 711/103; 711/173

(57) ABSTRACT

A Method for repeatedly recording a program in a flash memory is utilized to record a revised application program into a planned flash memory after the program is edited. The flash memory comprises a fixed program zone used to store never-revised fixed programs, an application program zone used to store revisable application programs and a callback function entrance point zone used to store an entrance point matrix. The starting address values of all callback functions in the application zone called by the fixed programs are stored in the entrance point zone. Therefore, only the program codes of the callback entrance point zone and the application program zone parts need to be recorded when the flash memory is recorded. Consequently, recording efficiency can be upgraded and program maintenance time can be reduced.

### TECHNICAL FIELD

The present invention relates to a method for repeatedly recording a program in a flash memory, and more particularly to a method for repeatedly recording a program in a flash memory after a program entrance point matrix is planned in the flash memory.

### TECHNICAL BACKGROUND

A flash memory is a memory used in a plurality of mobile devices for storing an operation system. A flash memory is also used in a cellular telephone, digital memory, LAN transformer, PC card, Set-top-box or insert type controller. The flash memory, which a whole zone is read in only one time, is much faster than EEPROM, which is read by byte every time. The flash memory is used in a new kind of computer as an element for storing BIOS so that a general user can update BIOS without a particular burner.

The more MMI (Man Machine Interface) is popular, the more the complexity and the length of software are increased, and the more the work share and integration of software are definite. To a software engineer, all programs must be recoded through a compiler after a part of a program is revised. Therefore, new codes are always a slight change in one part may effect the whole situation.

As FIG. 1 shows, complete cellular telephone software comprises application programs (such as MMI application program) of an upper layer and fixed programs (such as driver program, Internet Protocol program, operating system, character pattern, graph file and image file). Most fixed programs are not changed or moved when an engineer revises a part of an application program. But, a callback function in an application program changes its original address after the application program is partly revised. As FIG. 2 shows, a revised application program A′, which a program A in the fixed program zone wants to connect with, changes the address of its callback function after it is revised. Therefore, all programs must be recompiled through a compiler and recorded again. Thereby, the fixed program can call the callback function in the application program and an abnormal operation of a system can be avoided. But unfortunately, the whole process is time-consuming, complex and money costing.

### BRIEF DESCRIPTION OF THE PRESENT INVENTION

A method for repeatedly recording a program in a flash memory according to the present invention mainly add the concept of program entrance point matrix into the structure of cellular telephone software in the process of cellular telephone software recording. It only needs to enter the entrance point matrix to find out the starting address of the callback function through an address-mapping table (AMT) when the program in the fixed program zone needs to call the callback function in the application program zone.

Therefore, the main object of the present invention is to provide a method for repeatedly recording a flash memory. Only the program codes in the callback function entrance point zone and the application program zone need to be recorded, and the program codes in the fixed program zone need not to be recorded again after a revised application program is compiled, so that the recording time can be reduced.

Another object of the present invention is to provide a method for repeatedly recording a program in a flash memory. To the point view of program design, storing mature and complete programs in the fixed program zone of a memory, storing developing and need-to-be-maintained-or-revised programs in the application program zone, and only adding its starting address into the entrance point matrix can improve the recording efficiency in such a repeatedly recording process, as well reduce the program maintenance time.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 is a schematic view for the structure of general cellular telephone software;

FIG. 2 is a schematic view showing the structure change of the conventional flash memory after being compiled and revised through a compiler;

FIG. 3 is a schematic view showing a memory planning of a preferred embodiment of the present invention;

FIG. 4 is a schematic view showing the program calling motion in a program entrance point matrix according to a preferred embodiment of the present invention; and

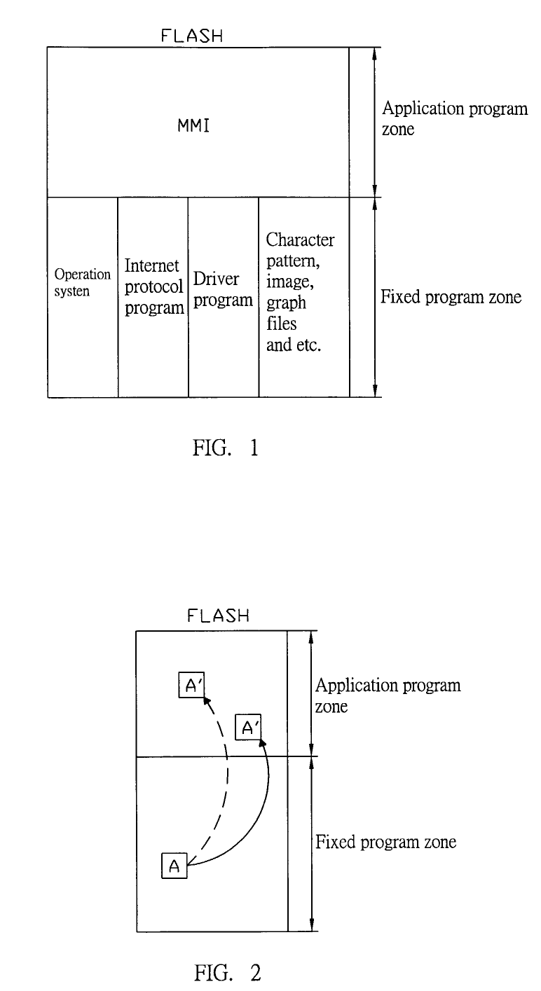

FIG. Is a schematic view, showing the motion for a fixed program calling a callback function before and after a program is re-compiled according to a preferred embodiment of the present invention.

### DETAILED DESCRIPTION OF THE PRESENT INVENTION

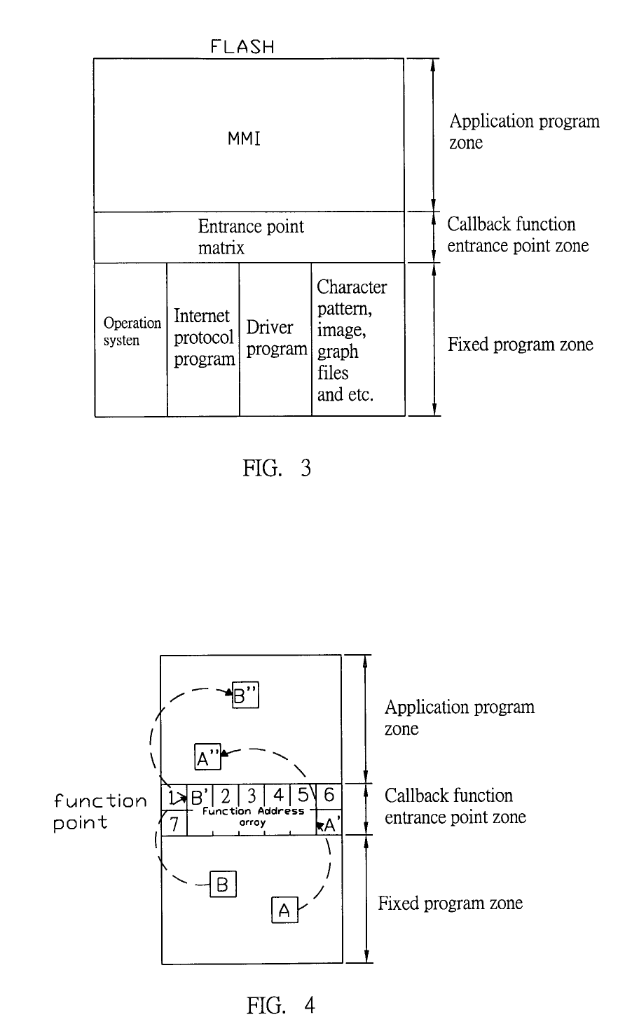

First, please refer to FIG. 3, which shows a memory planning according to a preferred embodiment of the present invention. A memory is divided into three parts in the figure: a fixed program zone, callback function entrance point zone and application program zone. The programs (such as operating system, driver program, Internet Protocol program, operating system, character pattern, graph file and image file) that are recorded completely and need no changes are stored in the fixed program zone. The application programs (MMI) that need to be revised or changed are stored in the application program zone. And, the callback function entrance point zone is a callback function entrance point matrix, this matrix record all the starting addresses of callback functions. A fixed program calls a callback function through the starting address of the starting function.

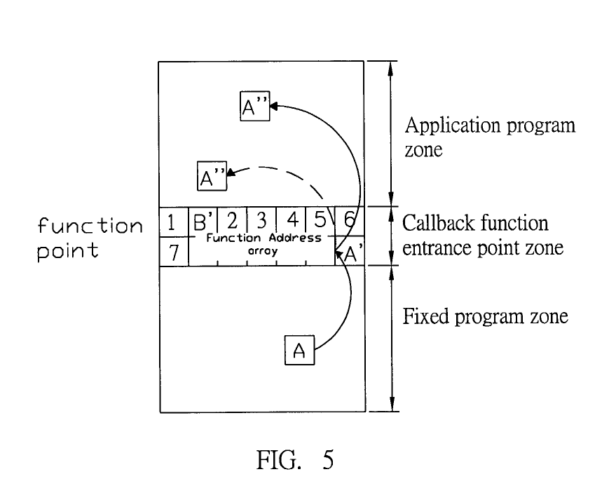

Next, referring to FIG. 4. When a fixed program A or B in the fixed program zone wants to call a callback functions A″ or B″ in the application program zone, it needs to go to the callback function entrance point zone to find out a starting address value A′ or B′ in a callback function address mapping table. And then, enters the application program zone to call the function A″ or B″ to complete the low layer fixed program calling motion. Therefore, not matter how the application program is revised the starting address of the callback function in the application program zone is always recorded in the entrance point matrix of the callback function entrance point zone. When a lower layer fixed program wants to call an upper layer callback function, it only needs to enter this entrance point matrix to find out the starting address of the upper layer callback function through the address-mapping table.

Finally, please refer to FIG. 5, which shows the motion that a fixed program calls a callback function before and after a program is recompiled according to the present invention. When an application program is revised and compiled, a callback function A′ in the application zone that a fixed program A wants to call will change its starting address, and a starting address value A′ will change too. But, the fixed program A still stays at the same address. Therefore, under this situation, after an engineer revises and compiles an application program, he only needs to record callback function address values into the entrance point zone and program codes into an application program zone. But, the program codes in the fixed program zone do not need to be recorded again. Therefore, the part of the fixed program zone recording time can be saved.

From the description mentioned above, to the point view of the program design, storing mature and complete programs in the fixed program zone of a memory, storing developing and need-to-be-maintained-or-revised programs in the application program zone, and only adding its starting address into the entrance point matrix when programs in the fixed program zone needs to call callback functions in the application zone can improve the recording efficiency in such a repeatedly recording process, as well reduce the program maintenance time.

A method for repeatedly recording a program in a flash memory according to the present invention is used practically on a cellular telephone software recording; add a program entrance point matrix into the structure of the cellular telephone software. A result shows that the recording time needed for the new structure is only one tenth of the recording time for the original structure.

It is noted that the retractable keyboard taken as a device used for listening and hanging up a telephone described above is the preferred embodiment of the present invention for the purpose of illustration only, and are not intended as a definition of the limits and scope of the invention disclosed. Any modifications and variations that may be apparent to a person skilled in the art are intended to be included within the scope of the present invention.

What is claimed is:

1. A flash memory, divided into three parts through a memory planning, said three parts are:
A fixed program zone, comprising completely recording and never-revised programs;
An application program zone, comprising revisable and changeable application programs; and
A callback function entrance point zone, comprising a callback function entrance point matrix, wherein all starting address values of callback functions in said application program zone called by fixed programs are recorded.

2. A method for a fixed program calling a callback function in a flash memory, used in the flash memory of claim 1, when a fixed program in a fixed program wants to call a callback function in an application program zone, said fixed program first going to a callback function entrance point zone to find out a starting address value of said callback function in a callback function address mapping table, then entering a starting address of said callback program in said application program zone.

3. A method for repeatedly recording a program in a flash memory, recording a revised program in the flash memory of claim 1 after said revised program is compiled.

4. The method of claim 3, only the program codes of said callback function entrance zone and said application program needing to be recorded.

5. A flash memory planning method, mainly comprising the following steps:
(1) dividing a flash memory into three parts: a fixed program zone, an application program zone and a callback function entrance point zone;
(2) storing mature and complete programs in said fixed program zone;
(3) storing developing or need-to-be-maintained-or-revised programs in said application zone; and
(4) adding starting addresses of callback functions into an entrance point matrix of said callback function entrance point zone.
